(19) United States
(12) Patent Application Publication
(10) Pub. No.: US 2025/0075558 A1
(43) Pub. Date: Mar. 6, 2025

(54) TRESTLE LADDER

(71) Applicant: LITTLE GIANT LADDER SYSTEMS, LLC, Springville, UT (US)

(72) Inventors: B. Scott MAXFIELD, Mapleton, UT (US); N. Ryan MOSS, Mapleton, UT (US); Darius S. PENROD, Elberta, UT (US)

(73) Assignee: LITTLE GIANT LADDER SYSTEMS, LLC, Springville, UT (US)

(21) Appl. No.: 18/820,081

(22) Filed: Aug. 29, 2024

Related U.S. Application Data
(60) Provisional application No. 63/579,764, filed on Aug. 30, 2023.

(51) Int. Cl. E06C 1/38; E06C 1/12; E06C 1/18; E06C 7/06; E06C 7/48

(52) U.S. Cl. CPC E06C 1/38; E06C 1/12; E06C 1/18; E06C 7/06; E06C 7/48

(57) ABSTRACT

A ladder includes a first and second assembly, each including a pair of spaced apart rails and a set of rungs coupled to and extending between the spaced apart rails. A pair of brackets slidably receive a pair of the spaced apart rails. A pair of protrusions extend from those spaced apart rails and are movable into a pair of slots defined by a pair of retainers coupled with the other pair of spaced apart rails. The protrusions are movable into the slots while the ladder is in a step ladder configuration at a nonzero angle between the first and second assemblies, such as by moving the pair of retainers from a locking position to an unlocked position as the rails bearing the protrusions longitudinally slide relative to the pair of brackets. The ladder may also have spreaders with limited movement while collapsed and spaced apart rung retainers.

### CROSS-REFERENCE TO RELATED APPLICATIONS

This application claims the benefit of U.S. Provisional Patent Application No. 63/579,764, filed 30 Aug. 2023, the disclosure of which is incorporated by reference herein in its entirety.

### BACKGROUND

Ladders are conventionally used to provide a user thereof with improved access to elevated locations that might otherwise be inaccessible. Ladders come in many shapes and sizes, such as straight ladders, extension ladders, step ladders, and combination step and extension ladders. “Combination” ladders (sometimes referred to as articulating ladders) may incorporate, in a single ladder, many of the benefits of multiple ladder designs and can be user-configured to imitate multiple other ladders.

Straight ladders, extension ladders or combination ladders (when configured as straight or an extension ladder), are ladders that are conventionally positioned against an elevated surface, such as a wall or the edge of a roof, to support the ladder at a desired angle. A user then ascends the ladder to obtain access to an elevated area, such as to an upper area of the wall or access to the roof. A pair of feet or pads, one being coupled to the bottom of each side rail, is conventionally used to engage the ground, a floor, or some other generally horizontal supporting surface.

Step ladders and combination ladders (when configured as a step ladder) are generally considered to be “self-supporting” in that they include a first rail assembly which includes steps or rungs that is coupled to a second rail assembly or other support structure. The first and second rail assemblies in a step ladder configuration are typically positioned at an acute angle relative to each other so that there are multiple feet or support members—at least three, but typically four—to support the ladder in a free standing position. Thus, the ladder may be used “freestanding” and without the need to lean the ladder against a wall or other vertical support structure. The free standing or step ladder configuration can be referred to as a trestle ladder configuration or an A-frame standing configuration.

Some combination ladders are convertible from a step ladder to an extension ladder by pivoting at a top hinge that joins the first and second rail assemblies. Some also have a rear rail assembly configured to extend or retract while parallel to the front rail assembly so that while in a straight or extension ladder configuration, the ladder can have a user-adjustable overall length. However, these combination ladders can be unstable or cumbersome to use due to needing to be locked into place when reconfigured from a straight ladder configuration to a step ladder configuration, especially when a user is unfamiliar with the ladder mechanisms or is working quickly.

### SUMMARY

One aspect of the present disclosure relates to a ladder, comprising: a first assembly including a first pair of spaced apart rails and a first set of rungs coupled to and extending between the first pair of spaced apart rails; a second assembly including a second pair of spaced apart rails and a second set of rungs coupled to and extending between the second pair of spaced apart rails; a pair of brackets coupled with the second assembly and slidably receiving the first pair of spaced apart rails; a pair of protrusions extending from the first pair of spaced apart rails; and a pair of retainers movably coupled with the second pair of spaced apart rails and at least partially defining a pair of slots. The first pair of spaced apart rails may be movable relative to the pair of brackets between a first configuration and a second configuration, wherein, when in the first configuration, the first pair of spaced apart rails and the second pair of spaced apart rails are positioned at a nonzero angle relative to each other, and the pair of protrusions is positioned external to the pair of slots, and wherein, when in the second configuration, the first pair of spaced apart rails and the second pair of spaced apart rails are positioned at the nonzero angle relative to each other, and the pair of protrusions is positioned within the pair of slots. Sliding movement of the first pair of spaced apart rails relative to the pair of brackets may be configured to move the pair of retainers relative to the second pair of spaced apart rails.

In some embodiments, the pair of brackets is pivotable relative to the second assembly. The pair of protrusions may extend laterally from the first pair of spaced apart rails. The pair of retainers may be rotatably coupled with the second pair of spaced apart rails.

In some configurations, the ladder may further comprise a pair of biasing mechanisms biasing movement of the pair of retainers relative to the second pair of spaced apart rails. The pair of retainers may move against a pair of biasing forces applied by the pair of biasing mechanisms in response to a force applied by the pair of protrusions against the pair of retainers as the first pair of spaced apart rails moves relative to the pair of brackets from the first configuration to the second configuration. In some embodiments, at least one retainer of the pair of retainers includes a hooked surface defining a slot of the pair of slots. The ladder may further comprise a cover portion configured to cover a distal surface of at least one retainer of the pair of retainers. The first pair of spaced apart rails may be movable from the first configuration to the second configuration while constantly maintaining the nonzero angle relative to the second pair of spaced apart rails.

Another aspect of the disclosure relates to a ladder comprising: a first assembly including: a first pair of spaced apart rails, a first set of rungs extending between and coupled to the first pair of spaced apart rails, and at least one pin member laterally extending from the first pair of spaced apart rails; a second assembly including: a second pair of spaced apart rails, a second set of rungs extending between and coupled to the second pair of spaced apart rails, and at least one retainer member coupled with at least one rail of the second pair of spaced apart rails, the at least one retainer member being movable between an unlocked position relative to the at least one rail and a locked position relative to the at least one rail; and a hinge assembly rotatably coupling the first assembly with the second assembly. The first pair of spaced apart rails and the second pair of spaced apart rails may be movable via the hinge assembly to a spread apart configuration with an acute angle between the first pair of spaced apart rails and the second pair of spaced apart rails, wherein, when in the spread apart configuration and with the at least one retainer member in the locked position, the first assembly may be prevented from longitudinal movement relative to the hinge assembly due to contact between the at least one pin member and the at least one retainer member, and wherein, when in the spread apart configuration and with the at least one retainer member in the unlocked position, the first assembly is longitudinally movable relative to the hinge assembly.

In some embodiments, the at least one retainer member at least partially defines a slot when in the locked position. The at least one pin member may comprise a bar extending between top ends of the first pair of spaced apart rails. The second assembly may further comprise at least one biasing member configured to apply a force to the at least one retainer member, with the force biasing the at least one retainer member toward the locked position. The at least one retainer member may be movable from the locked position to the unlocked position in response to a force applied by the at least one pin member against a distal surface of the at least one retainer member. The at least one retainer member may be movable from the locked position to the unlocked position by the force applied by the at least one pin member against the distal surface of the at least one retainer member when the first pair of spaced apart rails and the second pair of spaced apart rails are at the acute angle. The first assembly may comprise a cover member configured to limit user access to a distal surface of the at least one retainer member when the at least one pin member is contacting a proximal surface of the at least one retainer member.

Yet another aspect of the disclosure relates to a ladder, comprising: a first assembly including: a first pair of spaced apart rails; a first set of rungs extending between and coupled to the first pair of spaced apart rails; and a second assembly including: a second pair of spaced apart rails; a second set of rungs extending between and coupled to the second pair of spaced apart rails; and at least one spreader assembly including: a first spreader member rotatably coupled with a first rail of the first pair of spaced apart rails; and a second spreader member rotatably coupled with a second rail of the second pair of spaced apart rails, with the second spreader member being rotatably coupled with the first spreader member between the first rail and the second rail. The at least one spreader assembly may be movable between an extended configuration and a collapsed configuration, wherein, when in the extended configuration, the at least one spreader assembly holds apart the first rail and the second rail, and wherein, when in the collapsed configuration, a portion of the at least one spreader assembly prevents rotation of the first spreader member or the second spreader member beyond a volumetric envelope collectively defined by the first assembly and the second assembly.

In some embodiments, the portion of the at least one spreader assembly may comprise a bracket limiting a range of rotation of the first spreader member beyond the volumetric envelope. The portion of the at least one spreader assembly may comprise an abutment member extending laterally from the first spreader member between an outermost surface of the first rail and an outermost surface of the second rail, with the abutment member being configured to engage at least one of the first rail and the second rail in response to rotation of the first spreader member relative to the first rail. The portion of the at least one spreader assembly may include a stop surface on the first spreader member, with the stop surface being configured to engage the second spreader member when in the collapsed configuration.

The above summary of the present invention is not intended to describe each embodiment or every implementation of the present invention. The figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an isometric view of a ladder in a step ladder configuration.

FIG. 2 is a front view of the ladder of FIG. 1.

FIG. 3 is an isometric view of the ladder of FIG. 1 in a collapsed configuration.

FIG. 4 is an isometric view of the ladder of FIG. 1 in a straight ladder configuration.

FIG. 5 is an isometric view of a top end of the ladder of FIG. 1.

FIG. 6 is a right side view of the top end of the ladder of FIG. 1.

FIG. 7 is a right side view of the top end of the ladder of FIG. 1 with a hinge plate removed.

FIGS. 8-12 show right side views of the top end of the ladder of FIG. 1 as it moves through a sequence of unlocking movements from the free standing configuration.

FIGS. 13-17 show right side views of the top end of the ladder of FIG. 1 as it moves through a sequence of locking movements of the protrusions and retainers to the free standing configuration.

FIG. 18 shows an isometric view of the ladder of FIG. 1 at the spreader assemblies.

FIG. 19 shows a right side central cross-section of an upper end of the ladder of FIG. 1.

FIG. 20 shows a right side central cross-section of the upper end of the ladder of FIG. 3.

FIG. 21 shows an isometric view of a laterally inward side of the front rails and a spreader assembly of an example ladder in a collapsed condition.

FIG. 22 shows an isometric view of a laterally inward side of the front rails and a spreader assembly of an example ladder in a collapsed condition.

FIG. 23 shows a right side central cross-section of an upper end of the ladder of FIG. 4.

FIG. 24 is an isometric view of a top end of a ladder having an alternate v-bar.

FIG. 25 is a right side view of the ladder of FIG. 24.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Combination ladders, such as trestle ladders, can be difficult, unstable, and cumbersome to use. The rear assembly of the ladders can be configured to slide between extended and retracted positions relative to the front assembly, and in order for the rear assembly to remain fixed in position relative to the front assembly while the ladder is in a step ladder or freestanding configuration, the rear assembly needs to be retained by a retention mechanism or locking assembly. The retainers of the retention mechanism can receive one or more pins or protrusions extending laterally from the rails of the rear assembly in order to prevent unwanted sliding movement of the rear assembly relative to the front assembly. However, it can be difficult for a user to retain the pins or protrusions in the retainers, especially while working quickly. It can also be difficult for the user to determine whether the pins or protrusions are properly locked in place from a distance or at a glance. If the ladder is in a step ladder configuration, pins or protrusions may be out of position when the user begins to place a load on the ladder, thereby leading to unexpected sliding of the rear rails and the ladder falling down. Additionally, the ladder may need to be lifted and moved to an at least partially collapsed position before the pins or protrusions can be moved into a retained position, causing user fatigue and slowing down their workflow.

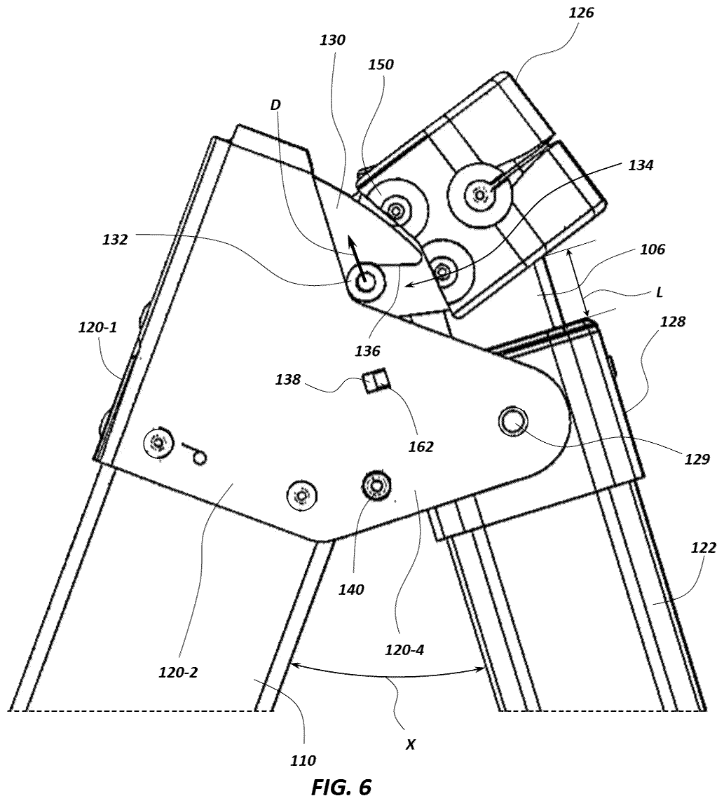

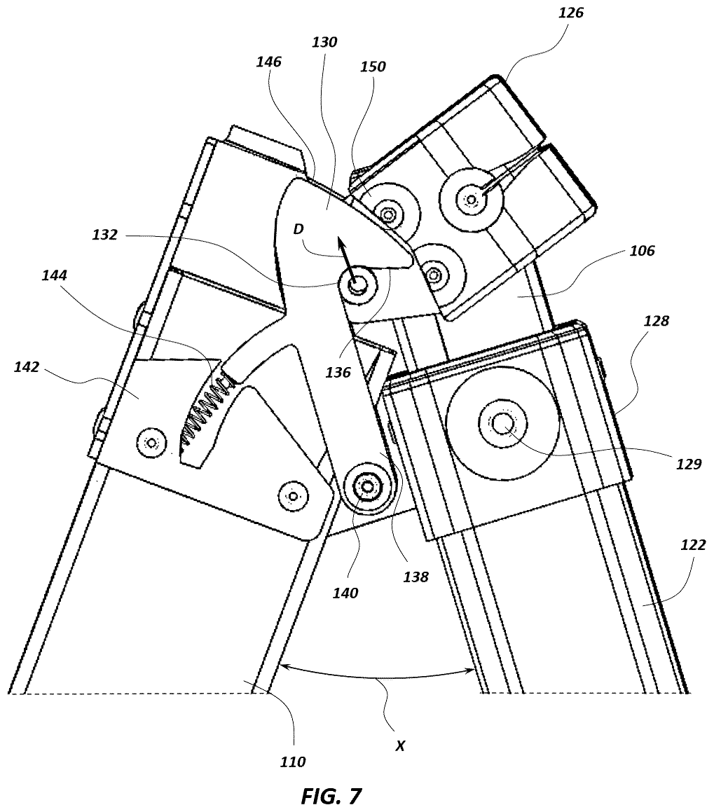

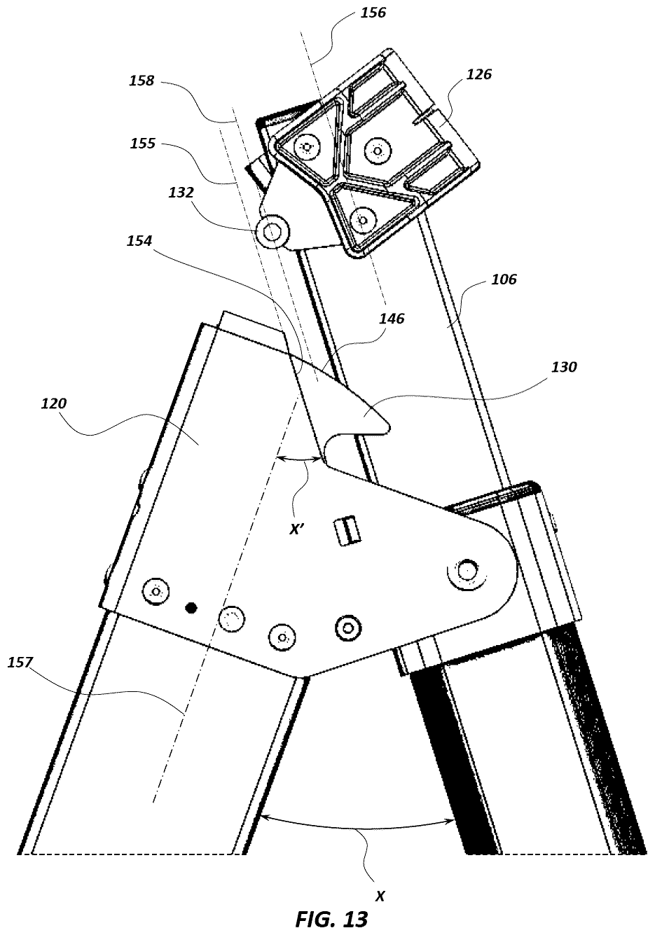

Embodiments of the present disclosure relate to combination ladders and similar ladders that can more securely and easily prevent unwanted sliding of the rear rail assembly relative to a front rail assembly. For example, a ladder can comprise a pair of protrusions extending (e.g., laterally) from the rear rails and a pair of retainers movably coupled with the front rails and at least partially defining a pair of slots. The pair of retainers can be movable between different configurations in response to sliding movement of the rear rails within a pair of brackets. See FIGS. 13-17. As the ladder is converted from a straight ladder or extension configuration to a step ladder or freestanding configuration, the pair of protrusions can come into contact with the pair of retainers, can then displace the retainers out of the path of motion of the pair of protrusions, and can then move to a position where the retainers hold the protrusions in place. The pair of retainers can be biased by a biasing mechanism (e.g., spring) that urges them toward a retention position after the protrusions have moved out of contact with the distal or top surfaces of the retainers. See FIG. 7. In this manner, the ladder can be moved into a locked step ladder configuration, with the protrusions held in place by the retainers (as shown in FIG. 6), from an unlocked step ladder configuration, with the protrusions not being held in place by the retainers (as shown in FIG. 13). Thus, a user does not need to move the front and rear assemblies of the ladder into a collapsed (or nearly collapsed) state in order to transition from the straight configuration to the locked step ladder configuration. Additionally, the movement of the retainers can provide an audible and/or haptic click as they move into the locked position, thereby assisting the user in determining that the ladder is fully in the locked step ladder configuration.

A cover member or v-bar can be provided that limits or prevents tampering with the retainers while the retainers are in the locked configuration so that the protrusions are not inadvertently unlocked or released. The cover member can also leave portions of the retainers exposed and visible so that a user can easily, visibly determine whether or not the protrusions are locked in place by the retainers.

In some example embodiments, the ladder may also include one or more spreader assemblies that help retain the relative positions of the front and rear assemblies in the step ladder position (i.e., prevent the rails from collapsing toward each other). The spreader assemblies can be unlocked and collapsed to allow the front rails to collapse toward the rear rails by pivoting at a support bracket. While the spreader assemblies are in their unlocked and collapsed position, the spreader assemblies can have their movement in a front-to-back (or vice versa) direction constrained by a portion of the spreader assemblies that comes into contact with rotating bar members of the spreader assemblies. The portion of the spreader assemblies can be a flange, protrusion, rivet, rod, pin, stop surface, or bracket that mechanically interferes with movement of a rotating member of the spreader assembly or that comes into contact with a rail, rung, or other nearby ladder component in a manner that restricts the range of motion of the spreader members while they are in the collapsed configuration. In this manner, the spreader assemblies can be prevented from moving beyond a volumetric envelope collectively defined by the first assembly and the second assembly, such as a volumetric envelope positioned between a front surface plane of the front pair of rails and a rear surface plane of the rear pair of rails.

Additionally, in some examples, the ladder may comprise a pair of rung support members extending from the front assembly toward the rear assembly. The rung support members can be retainers comprising hooked or u-shaped top surfaces configured to receive a lower surface of a rung of the rear assembly while the rear assembly is in a straight ladder position or collapsed position. With the rung in the retainers, the rear assembly can be prevented from retracting by sliding relative to the front assembly. The rung of the rear assembly can be displaced out of the rung support members to adjust the overall length of the straight ladder, and then a different rung can be supported by the rung support members. The rung support members can be spaced apart to allow a user's hand to move between the rung support members while he or she adjusts the position of the rear rails and rungs. Thus, the user does not need to rotate the rear assembly to move their hand past the rung support members while grasping one of the rungs of the rear assembly.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

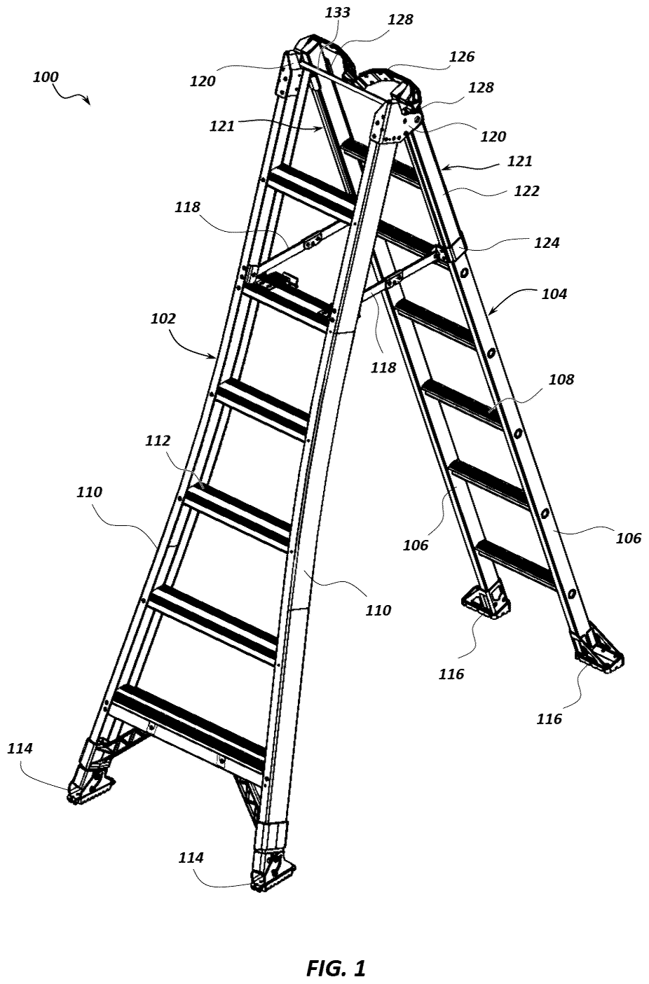

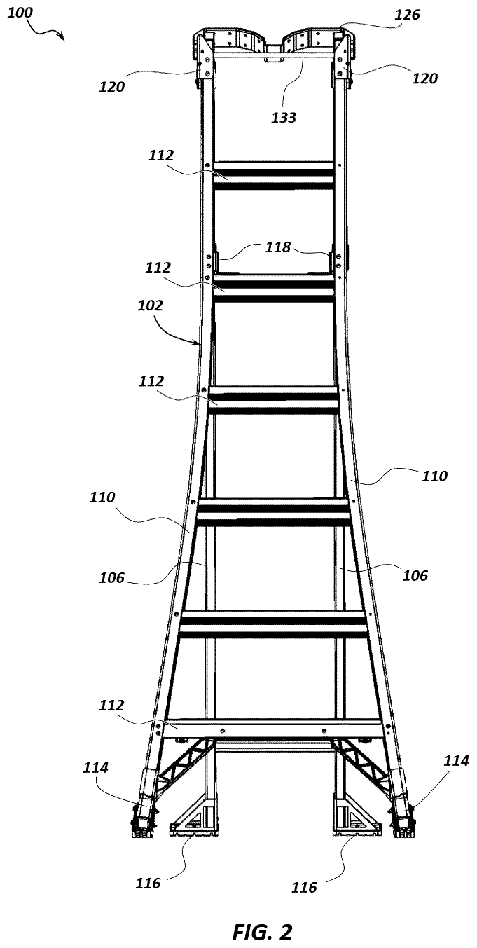

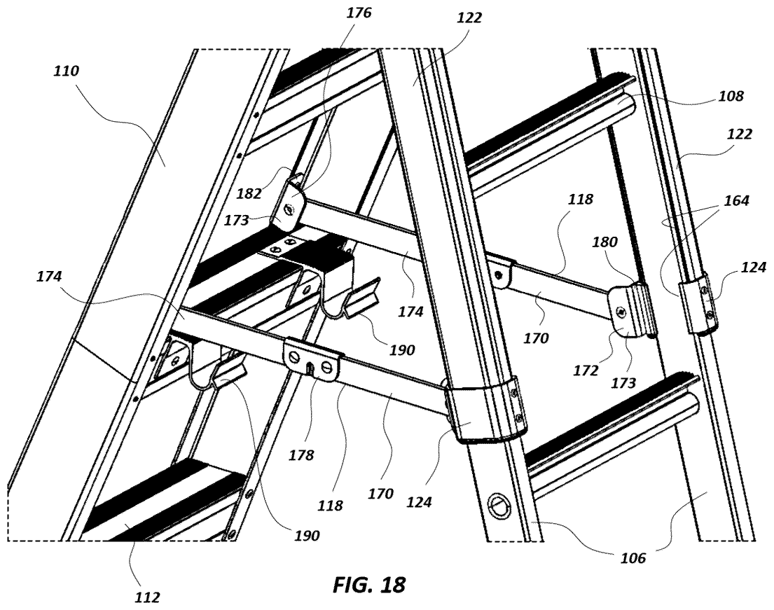

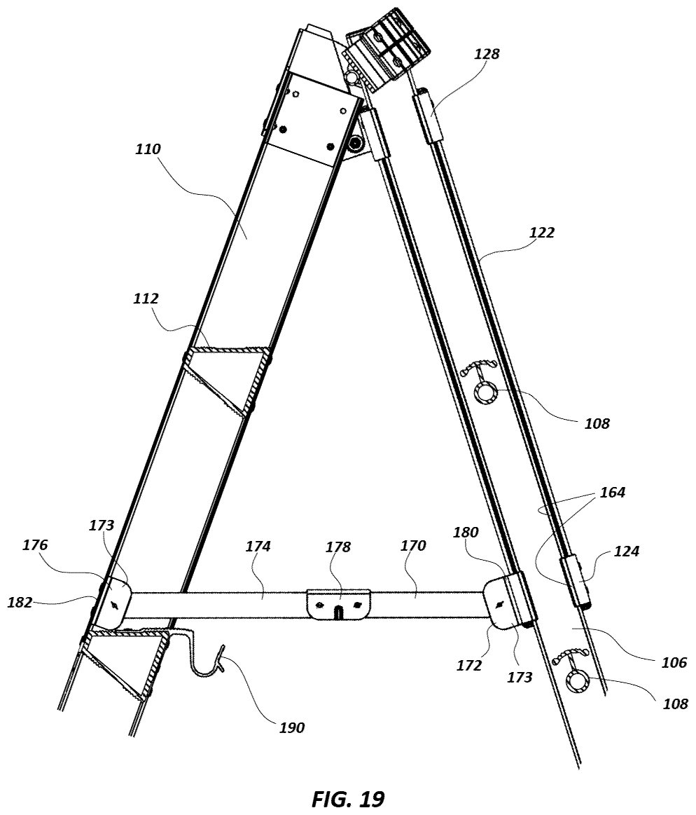

FIGS. 1-4 show a combination ladder 100 in various positional configurations. The combination ladder 100 may include a rear assembly 102 and a front assembly 104. The rear assembly 102 can alternatively be referred to as a first assembly, first rail assembly, or front rail assembly, and the front assembly 104 can alternatively be referred to as a second assembly, second rail assembly, or rear rails assembly. The rear assembly 102 can include a pair of spaced apart rails (i.e., rear rails 106) and a set of rear rungs (e.g., rear rung 108) directly coupled to and extending between the rear rails 106. The front assembly 104 can include a second pair of spaced apart rails (i.e., front rails 110) and a set of front rungs (e.g., front rung 112) directly coupled to and extending between the front rails 110. Each of the front assembly 104 and the rear assembly 102 can include one or more feet 114, 116 for supporting the ladder 100 while the ladder 100 is in a step ladder configuration (e.g., shown in FIGS. 1-2). A pair of spreader assemblies 118 can extend between the front assembly 104 and the rear assembly 102 to help retain the ladder 100 in the step ladder configuration, such as by maintaining an acute angle (e.g., angle X in FIG. 6) between the rear and front rails 106, 110. See also FIGS. 18-19 and their related descriptions herein.

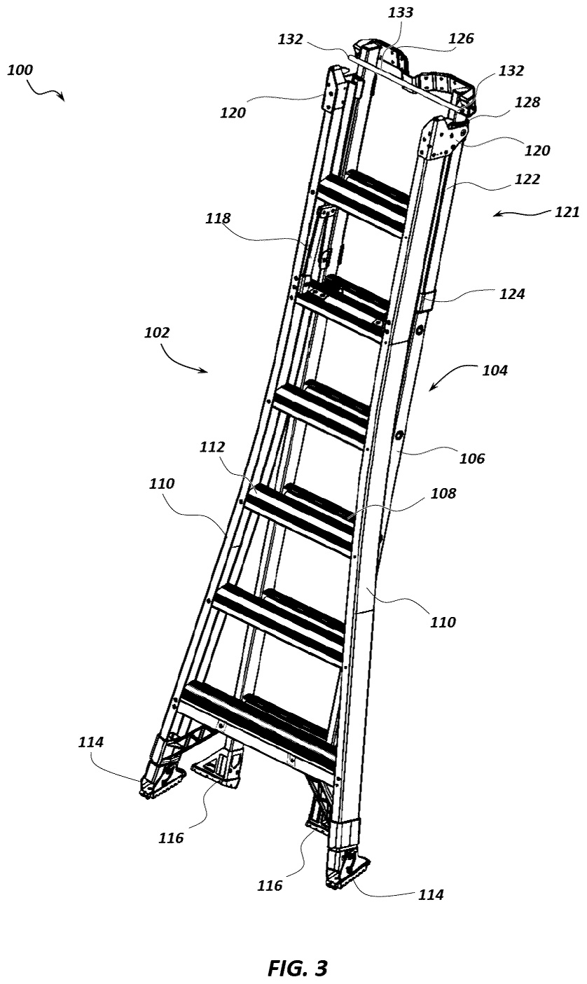

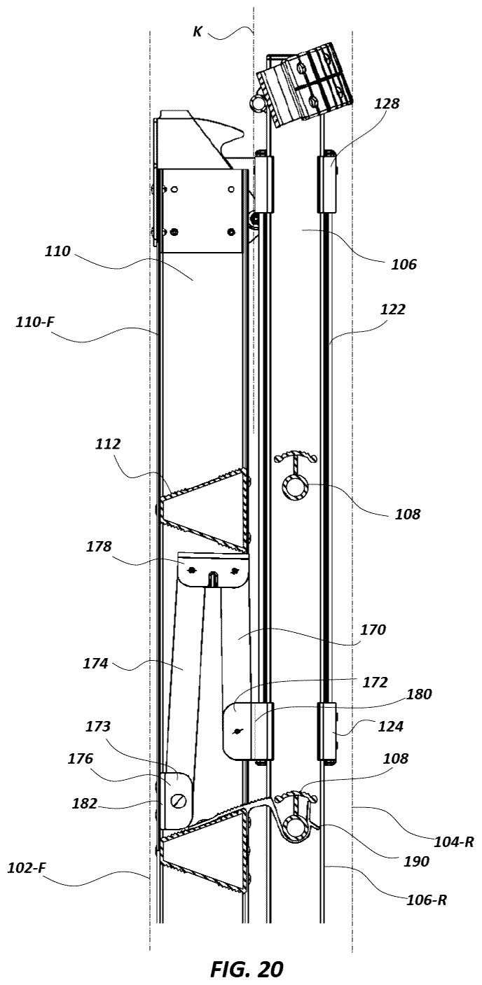

As used herein, a “front” or “frontward” direction refers to a direction facing away from a vertical center plane (e.g., plane K in FIG. 20) of the ladder 100 that is parallel to the front rails 110 and rear rails 106 while the ladder 100 is in a collapsed configuration (e.g., FIG. 3). A “rear,” or “rearward” direction refers to the opposite direction relative to the front direction, a “lateral” direction refers to a left or right direction perpendicular to the front and rear directions, an “outer lateral” direction refers to a left or right direction perpendicular to the front and rear directions and also oriented away from the center of the ladder (i.e., between the front rails 110 or between the rear rails 106), a “distal” direction refers to a direction away from the volumetric center of the ladder (e.g., facing upward at the top end of the ladder), and a “proximal” direction refers to a direction toward the volumetric center of the ladder (e.g., facing downward at the top end of the ladder).

Features referred to as being “substantially parallel” herein are considered to be angled at less than 5 degrees of angular offset relative to each other unless referred to as “parallel,” in which case the features would be angled at less than 1 degree of angular offset relative to each other.

As used herein, parts may be “coupled” to each other by being held to each other directly or indirectly (i.e., via intervening parts). Parts that are “directly coupled” are attached to each other directly (i.e., without intervening parts). Parts that are “slidably coupled” may be held together while also being slidable relative to each other, such as by being slidable with surfaces of the parts contacting each other or by being coupled but translatable relative to each other via intervening parts. Parts may be “attached,” “affixed,” or “mounted” to each other by being joined to each other without being movable relative to each other.

The rear rails 106 can be configured substantially parallel to each other along their entire lengths. In this manner, the rear rails 106 can slide through a pair of sliding support brackets 121 (as further described below) along most of their entire lengths without binding in the sliding support brackets 121. The front rails 110 can have upper ends (near hinge plates 120) that are spaced apart equal to the spacing of the rear rails 106, as shown in FIG. 2, and can have lower ends (near feet 114) that are flared or bowed outward to a wider distance than the upper ends. The increased width of the lower ends of the front rails 110 can improve stability of the ladder 100 by giving the ladder 100 a wider stance of support. A central portion of the front rails 110 (e.g., between the second-from-top front rung 112 and the second-from-bottom front rung 112) can include a bend that causes the lower ends of the front rails 110 to be wider than the upper ends thereof.

The rails 106, 110 can comprise a rigid metal (e.g., aluminum), wood, or composite (e.g., fiberglass) material for stiffness. The rear rungs 108 and the front rungs 112 can comprise similar materials and can provide a set of spaced apart footholds for a user climbing the ladder 100. In some embodiments, one or more rungs 108, 112 can be replaced by a cross-brace or other horizontal support extending between the rails 106, 110 that is not intended to be used as a step or foothold. The rungs 108, 112 can be positioned entirely between and within the front and rear surfaces of their respective rails 106, 110 in a manner minimizing the overall volumetric envelope of the ladder 100 when the ladder 100 is in the collapsed position (e.g., as shown in FIG. 3 and described in further detail in connection with FIG. 20).

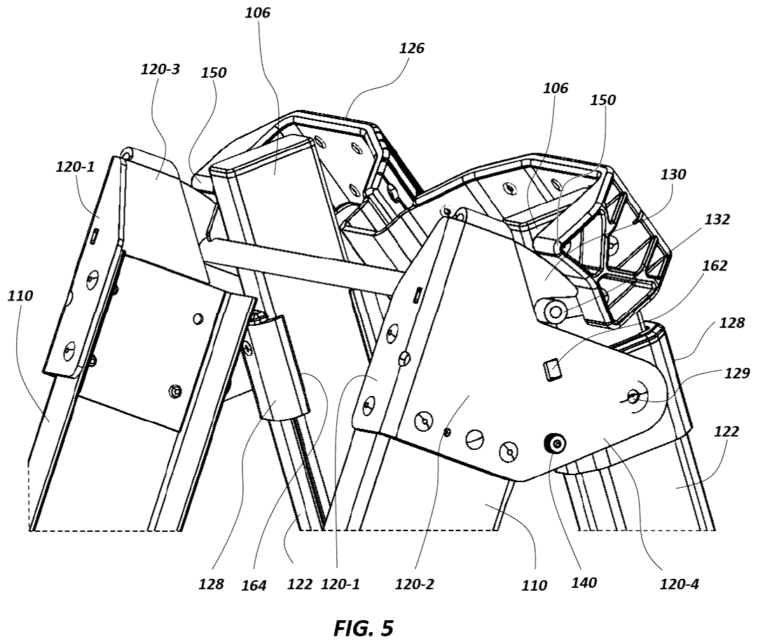

A pair of hinge plates 120 may be positioned at top ends of the front rails 110. The pair of hinge plates 120 may be pivotally connected to a pair of sliding support brackets 121 coupled with the rear assembly 102. The sliding support brackets 121 can be slidably coupled with and receive the pair of rear rails 106. Each sliding support bracket 121 can include an upper bracket 128, a rail shroud 122, and a lower bracket 124. The pivot axis of the hinge plates 120 and upper bracket 128 can extend through a pair of pivotal connections 129 (shown in FIGS. 5-6). Thus, the rear assembly 102 can be rotated relative to the front assembly 104 about the axis of rotation extending through the pivotal connections 129 on each side of the ladder 100. The maximum spread angle (e.g., the maximum pivot angle X when the ladder 100 is in the step ladder configuration) of the assemblies 102, 104 can be limited by the spreader assemblies 118 since the spreader assemblies 118 are directly coupled to the front rails 110 and to the lower brackets 124. In some examples, spreader assemblies 118 can be omitted from the ladder 100, and the protrusions 132, retainers 130, and other upper components at the hinge plates 120 described below can maintain the ladder 100 in a step ladder configuration when the protrusions 132 are in their locked positions in slots 134.

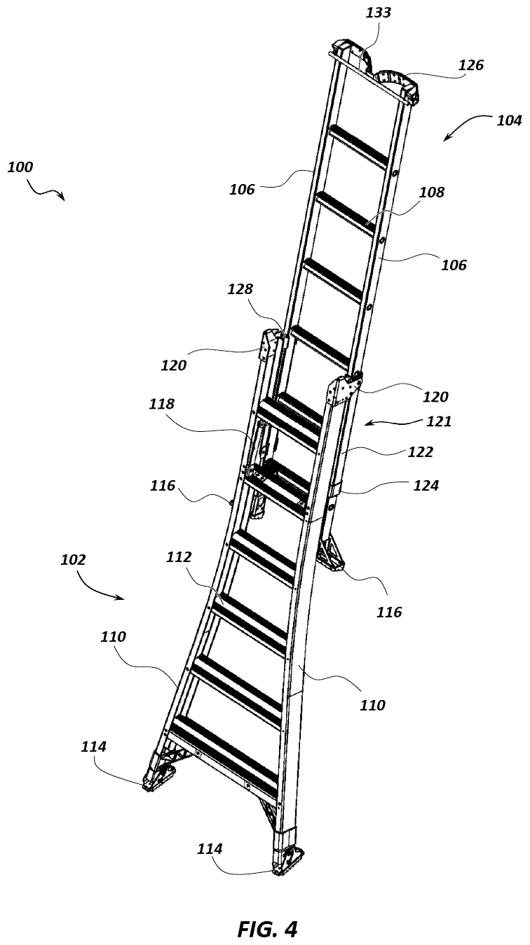

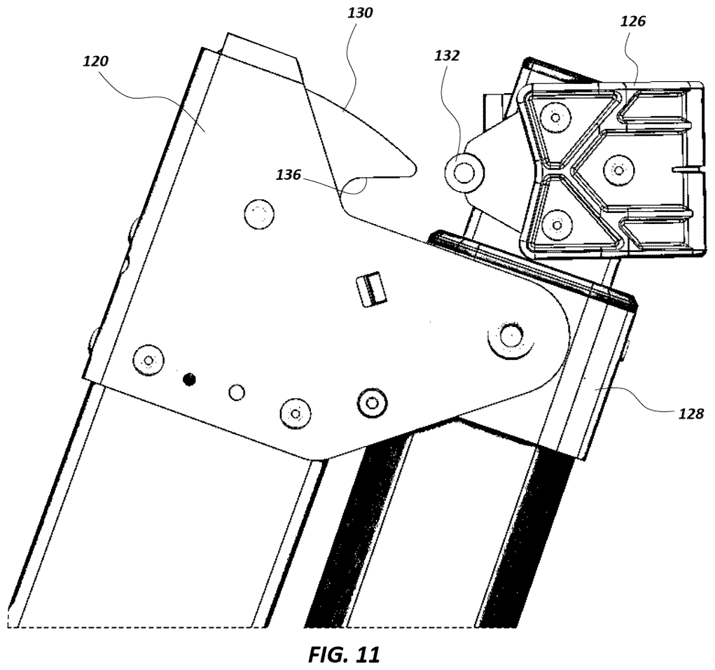

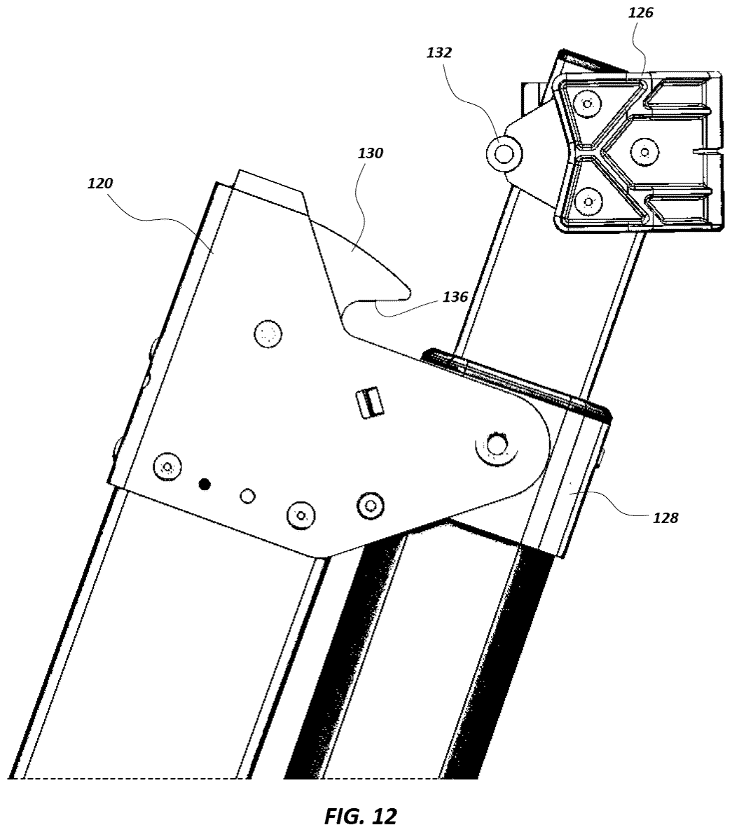

The rear assembly 102 can also pivot about the pivotal connections 129 to a collapsed configuration (shown in FIG. 3), also referred to as an approximated and substantially parallel assembly configuration, a fully retracted straight ladder configuration, or a fully overlapping rail configuration. While in or near the collapsed configuration, the rear rails 106 can move upward relative to the plates 120 to an extended position (shown in FIG. 4), also referred to as an extension position or a straight ladder configuration. See also FIGS. 11-12.

In the retracted position or the extended position, the ladder 100 can be supported in an elevated state by leaning against a vertical support surface, pole, or similar elevated structure. The ladder 100 can include a v-bar 126 or similar support structure or abutment member having angled outer surfaces and spaced apart surface geometries configured to support the upper ends of the rear rails 106 against a flat wall, an inside corner (e.g., two vertical support structures (e.g., walls) forming 90-degree inside corner), an outside corner (e.g., two vertical support structures forming a 90-degree outside corner), a pole, a rectangular pillar, a stud, and similar structures. In some examples, the v-bar 126 may be replaced by a straight bar or rung (e.g., 108), or it can be omitted. As shown in at least FIG. 5, the v-bar 126 can comprise an m-shaped profile, with extreme ends of the v-bar 126 (at cover portions 150) being positioned laterally and outwardly external to the rear rails 106.

As shown in FIGS. 5-6, the pair of plates 120 can be mounted to the top ends of the front rails 110. FIG. 5 shows an isometric view of the front of the ladder 100, and FIG. 6 shows a right side view thereof. FIG. 7 shows the right side view with the plate 120 removed. The plates 120 can wrap around the top ends of the front rails 110 to protect the ends of the rails. Thus, the plates 120 can include multiple wall portions 120-1, 120-2, 120-3 facing in different directions and wrapping around the rails 110. For example, a front wall portion 120-1 can be positioned facing in a forward direction and away from the front sides of the front rails 110, an outside wall portion 120-2 can be positioned facing laterally outward from the front rails 110, and a top or inside wall portion 120-3 can be positioned facing upward and/or laterally inward from the rails 110, as shown in FIG. 5. The plates 120 may also each have a rearwardly protruding portion 120-4 that extends rearward relative to the rear surfaces (i.e., the surfaces facing the rear rails 106) of the rails 110. The wall portions 120-1, 120-2, 120-3 and rearwardly protruding portion 120-4 (which can be part of wall portion 120-2) can be portions of a single piece of material (e.g., stamped steel or aluminum) that are bent into a final shape covering multiple sides of the front rails 110 and enclosing other components such as the retainers 130 and biasing members 144. See FIGS. 6-7 and their related descriptions below.

The pair of hinge plates 120 can at least partially cover and enclose a pair of retainers 130 movably coupled with one or more portions of the plates 120 or rails 110. The pair of retainers 130 can at least partially define a pair of slots 134 (see FIG. 6) configured to each receive one of a pair of protrusions 132 extending from the rear rails 106. The retainers 130 can be referred to as retainer members, protrusion retention hooks, gate hooks, or pivotable latches. The slots 134 may also be at least partially defined by one or more portions of the plates 120, such as outside wall portion 120-2 and rearwardly protruding portion 120-4. As shown in FIGS. 5-6, each protrusion 132 can be seated at the innermost end of its respective slot 134 while the ladder 100 is in a step ladder configuration. The rails 106, 110 can form a nonzero, acute angle X (see FIG. 6) between a plane defined by the rear-facing sides of the front rails 110 and a plane defined by the front-facing sides of the rear rails 106 (or by a plane defined by the front sides of the sliding support brackets 121) when the ladder 100 is in the step ladder configuration. Additionally, all of the feet (e.g., 114, 116) of the ladder 100 can be supported by a common plane or by on one or more horizontal surfaces while in the step ladder configuration.

The protrusions 132 can comprise pins, rods, or other protruding members that laterally extend from the outer side surfaces of the rear rails 106, as shown in FIGS. 3-5. In some embodiments, as shown in FIGS. 1-5, the protrusions 132 can be terminal end portions of a rod or bar 133 extending between and coupled to the rear rails 106. The bar 133 can reinforce the ends of the rear rails 106 and provide added stiffness to the ladder 100. The bar 133 can also be coupled with the v-bar 126 to improve the stiffness and weight bearing capacity of the v-bar 126. In some embodiments, the protrusions 132 can include flanges, pins, or pegs (e.g., rivets) extending laterally from the rear rails 106. In that case, the bar 133 between the rails 106 can be omitted.

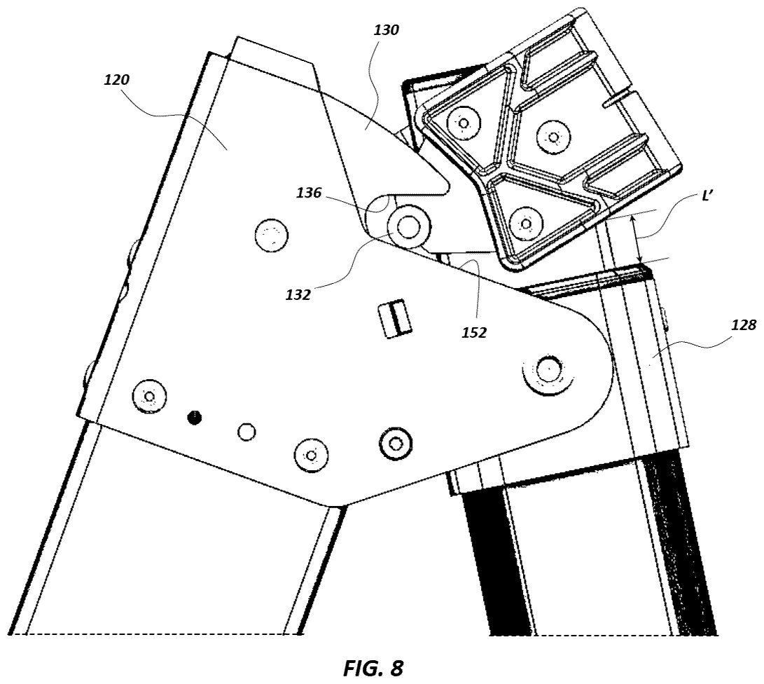

With the protrusions 132 seated in the slots 134, the rear rails 106 are prevented from sliding within the sliding support brackets 121 in at least a direction D (see FIGS. 6-7) that is directed toward the proximal surfaces 136 of the retainers 130 and parallel or substantially parallel to the longitudinal axes (e.g., 156 in FIG. 13) of the rear rails 106. The retainers 130 may mechanically block and interfere with any movement of the protrusions 132 in direction D due to contact between the protrusions 132 and proximal surfaces 136. The proximal surfaces 136 may be referred to as lower surfaces, inner surfaces, or hooked surfaces of the retainer 130. The proximal surfaces 136 may be substantially straight or may be hooked or curved around the protrusions 132 to cradle the protrusions 132 from multiple sides while in the locked position. For example, as shown in FIG. 7, the retainer 130 may have an upside-down J-shaped or L-shaped profile with a pivot end 138 that is substantially straight and a retaining end (including surfaces 136 and 146) that extends at an angle or curves away from the pivot end 138. Each proximal surface 136 may form an angle of less than 90 degrees relative to a directly vertical axis (e.g., a gravitational direction) extending through the proximal surface 136, such as an angle of about 87 degrees or about 88 degrees relative to the vertical axis, in order to help prevent accidental movement of the retainer 130 into a space between the hinge plate 120 and the front rail 110. The pivot end 138 can be directly pivotally coupled with the plate 120 (e.g., in protruding portion 120-4, as shown by pivoting connection 140 in FIG. 6). In some embodiments, the retainer 130 may have an L- or C-shaped profile for its proximal surface 136, each of which would dictate a different path for withdrawal of the protrusions 132 from the slots 134 when appropriate. Additional details about withdrawal of the protrusions 132 from the slots 134 are provided in connection with FIGS. 8-11 below.

A pair of retainer support members 142 can be directly coupled to lateral outer sides of the front rails 110 between the rails 110 and the plates 120. See FIG. 7. The pair of retainer support members 142 can each be coupled with an end of one of a pair of retainer biasing members 144. The retainer biasing members 144 may also each be coupled with a separate retainer of the pair of retainers 130. The biasing members 144 may comprise springs or other biasing structures configured to apply a biasing force against the retainers 130 in a manner that drives the retainers to rotate about pivoting connection 140 toward the position shown in FIGS. 6-7. In some embodiments, the biasing members 144 can include compression springs, extension springs, leaf springs, torsion springs, coil springs, gas springs, similar structures, and combinations thereof. Biasing members 144 can be positioned elsewhere on the ladder 100, such as at or around the pivoting connection 140. Under some conditions, a force applied to an upper or distal surface 146 of the retainer 130 can overcome the biasing force and can cause rotation of the retainer 130 in the opposite direction about pivoting connection 140, as described in further detail below. Retraction rotation of the retainers 130 (e.g., retraction behind plate 120) may be limited by contact between the structure of the pivot end 138 and a retainer support member 142. Tabs 162 in the plates 120 may limit extension rotation of the retainers 130.

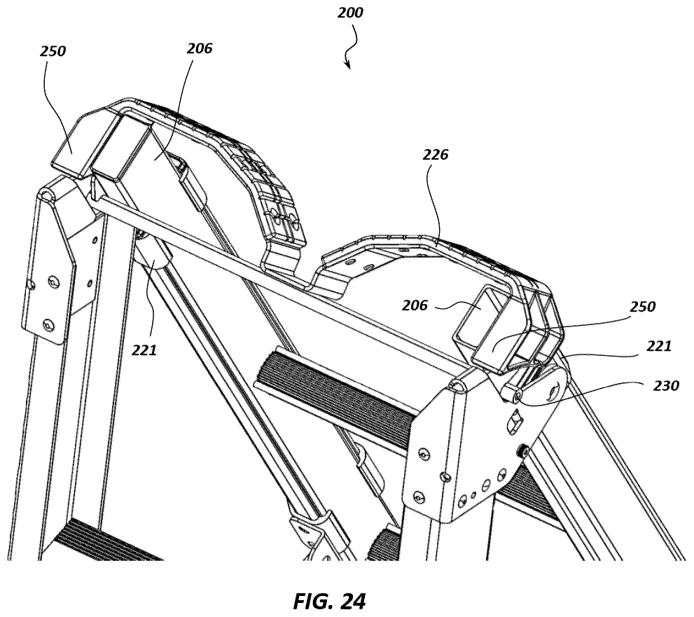

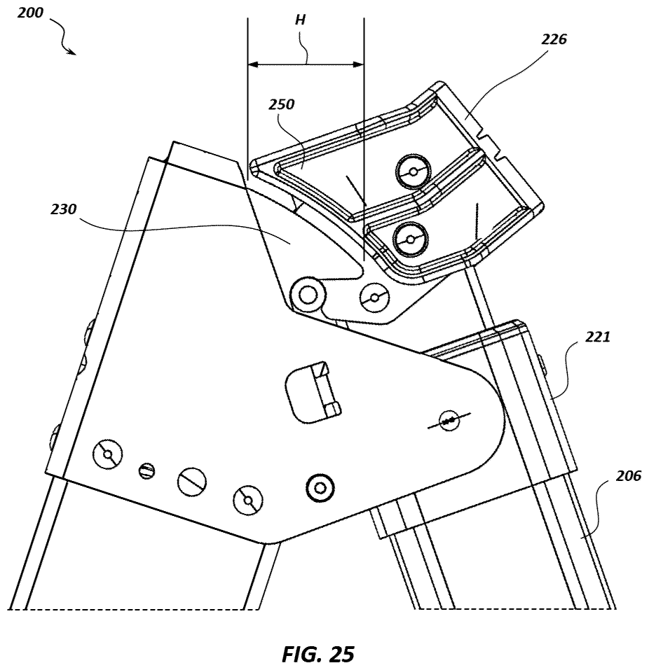

While in the locked position shown in FIGS. 6-7, the protrusions 132 can have their distal surfaces 146 at least partially covered (from above) by cover portions 150 of the v-bar 126. The cover portions 150 may be positioned laterally external to the rear rails 106 and vertically overlapping with the retainers 130 at the distal surfaces 146. Thus, with the cover portions 150 directly over the distal surfaces 146, user access to the distal surfaces 146 (e.g., via their fingers or tools) is limited or prevented. FIGS. 24-25 show a ladder 200 having a v-bar 226 configured to fully overlap and cover a set of retainers 230 to even further limit or prevent unintended actuation of the retainers 230. All other components of the ladder 200 may be similar to ladder 100, and ladder 100 may implement the features of ladder 200. To facilitate full overlap of the retainers 230, the v-bar 226 may have a cover portion 250 extending over the entire distal surface 246 when the rails of the ladder are configured in a freestanding position. Thus, each retainer 230 can have a horizontal width H (see FIG. 25) wherein all, or substantially all, of the width H is underneath a cover portion 250 when the rails are in an upright, angled configuration with protrusions 232 being retained by the retainers 230. The overhang of the cover portions 150, 250 relative to the retainers 130, 230 can beneficially prevent unexpected or unintentional unlocking of the retainers 130, 230 and releasing of the protrusions 132, 232, which would permit sliding of the rear rails 106, 206 in the sliding support brackets 121, 221 in undesirable conditions (e.g., when the user is standing on the ladder 100, 200).

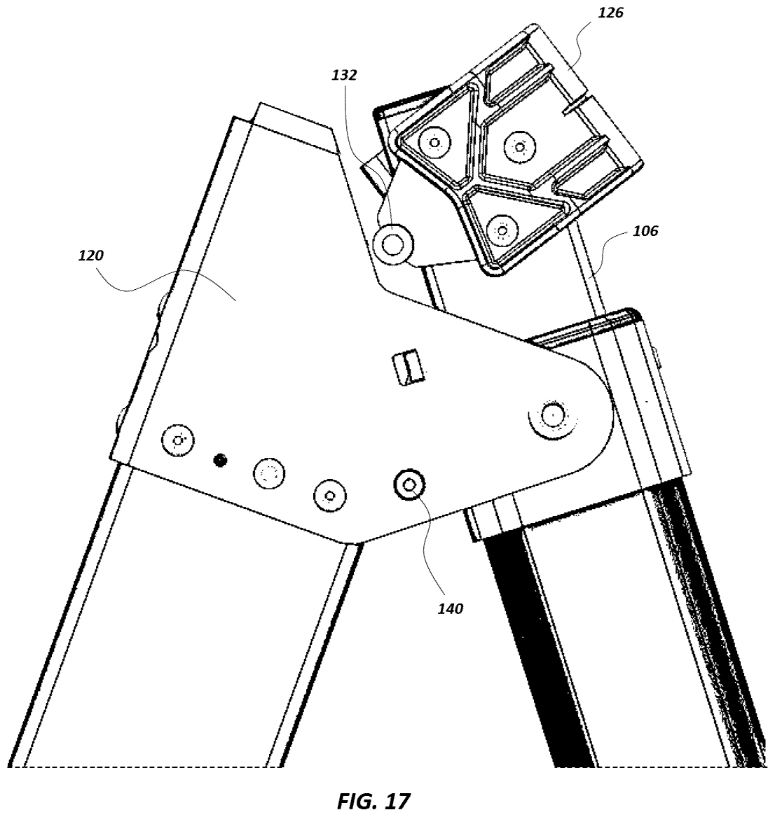

FIGS. 6 and 8-17 illustrate various potential positions of the protrusions 132 and retainers 130 relative to each other. Movement of the protrusions 132 from the locked position of FIG. 6 to the unlocked position of FIG. 11 can be referred to as an unlocking movement of the rear rails 106. Movement of the protrusions 132 (and retainers 130) from the unlocked position of FIG. 13 to the position of FIG. 17 (and then to the locked position of FIG. 6) can be referred to as a locking movement of the rear rails 106.

The unlocking movement of the rear rails 106 may be completed as follows. At the start, as shown in FIG. 6, the protrusions 132 may be seated against the proximal surfaces 136 of the retainers 130. The v-bar 126 may be offset from the upper brackets 128 by a length L. Application of a longitudinally downward-directed force on the rear rails 106 (e.g., in a direction opposite direction D) or a longitudinally upward force (e.g., upward along axis 157 shown in FIG. 13) on the front rails 110 (while the rear rails 106 remain substantially stationary) can allow the rear rails 106 (and protrusions 132) to slide downward relative to the sliding support brackets 121 as shown in FIG. 8. Accordingly, the length L may be reduced from its original length (as shown in FIG. 6) to a reduced length (L′, as shown in FIG. 8). The rear rails 106 may therefore slide longitudinally downward as the protrusions 132 begin to be separated from contact with the retainers 130.

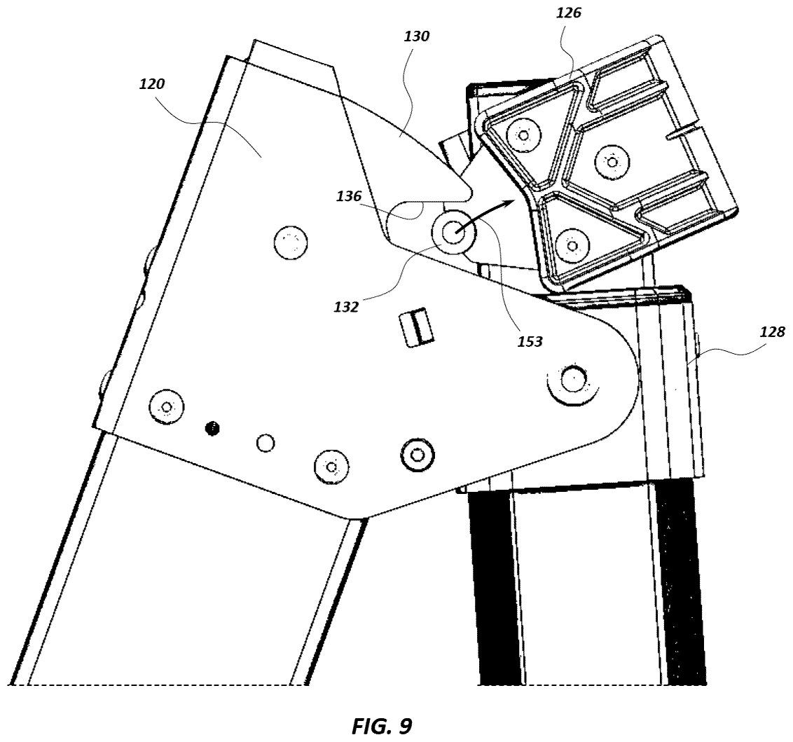

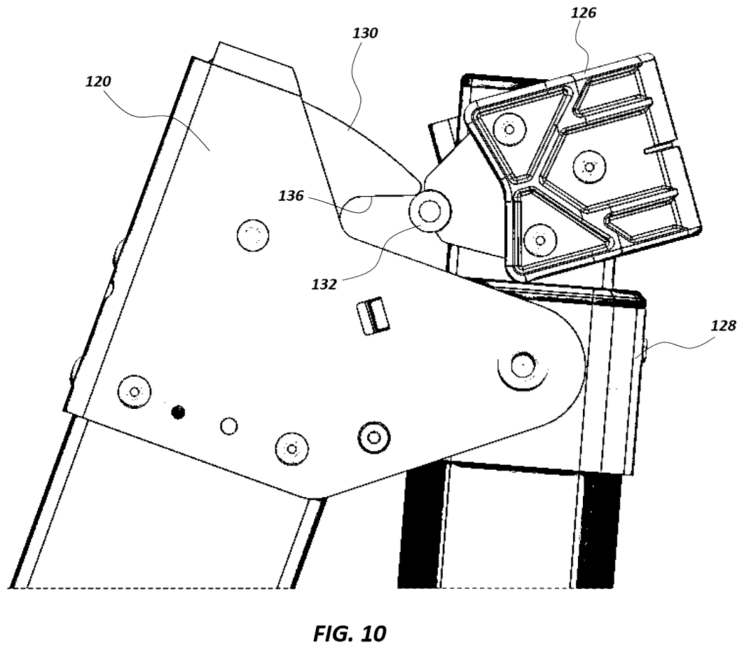

The protrusions 132 and rear rails 106 can be prevented from further longitudinally downward movement relative to the plates 120 by contact with distal or substantially-upward-facing surfaces 152 of the plates 120, as shown in FIG. 8. Thus, to further withdraw from the slots 134, the protrusions 132 rotate about the axis of pivotal connections 129 as the rear rails 106 continue to reduce length L until reaching the position shown in FIG. 9, wherein the length L reaches zero or substantially zero. From the position of FIG. 9, the protrusions 132 can continue to rotate about the pivotal connections 129 (e.g., along curved arrow 153) until clearing the proximal surface 136 of the retainer 130, as shown in FIGS. 10-11. Accordingly, the protrusions 132 can longitudinally slide while rotating about an axis of rotation (through 129) of the rear rails 106. Once reaching the position of FIG. 11, the rear assembly 102 may be longitudinally unlocked and capable of sliding within the sliding support brackets 121 to a user-selected extended position, as suggested by FIGS. 3, 4, and 12.

From the extended position of FIG. 4 (or the position of FIGS. 3 and 12), a user may wish to spread the assemblies 102, 104 apart to reach a step ladder configuration (e.g., as shown in FIGS. 1-2 and 6). The protrusions 132 may therefore need to be locked in place by the retainers 130 via the locking movement illustrated in FIGS. 13-17. A user may conveniently convert the ladder to the step ladder configuration by preliminarily opening the angle between the assemblies 102, 104 without the protrusions 132 being within the slots 134, as shown, for example, by the starting position shown in FIG. 13. From the extended and non-parallel-rails position of FIG. 13, the user can lock the spreader assemblies 118 in their fully deployed and locked positions, thereby orienting the rails 106, 110 and sliding support brackets 121 while maintaining the fully opened, nonzero angle X between the front and rear assemblies 104, 102. In some cases, the spreader assemblies 118 are partially deployed, and the assemblies 102, 104 may be oriented at less than angle X, but at a greater than zero angle, such as being at an angle between about 10 degrees and about 30 degrees. When fully opened (i.e., at angle X), the protrusion 132 may have its front-facing side aligned with a plane 155 extending through a pair of top guide surfaces 154 and being longitudinally aligned with the distal surface 146 of the retainer 130 (i.e., aligned with the distal surface 146 along an axis 158 parallel to the longitudinal axis 156 of the rear rail 106).

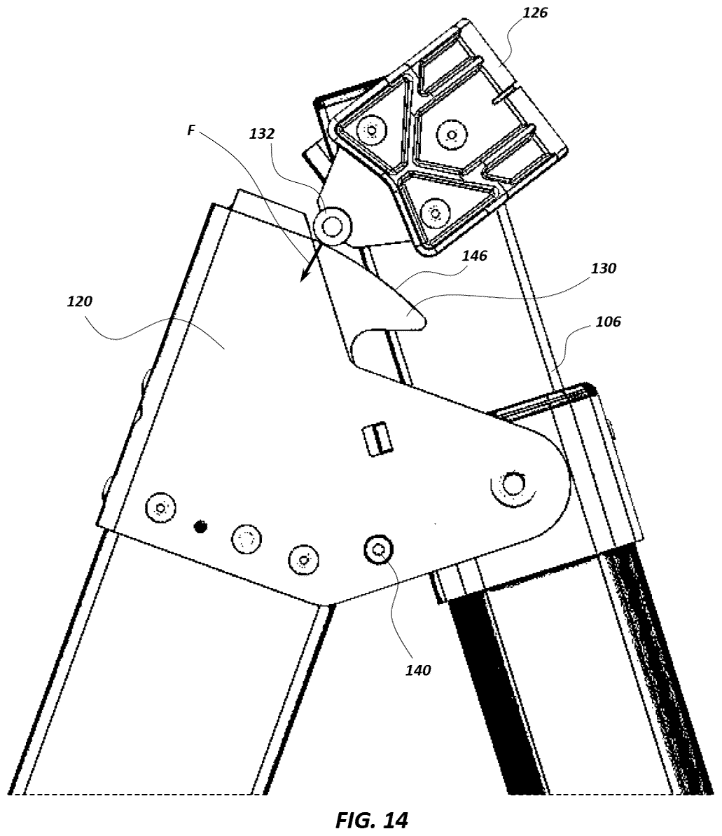

Accordingly, as the user longitudinally moves the rear rails 106 to lock the protrusions 132 in the retainers 130 (i.e., slides the rear rails 106 along the longitudinal axis 156 in a manner reducing length L between the v-bar 126 and the upper brackets 128), the protrusions 132 may come into contact with the distal surface 146, as shown in FIG. 14. The protrusions 132 may contact distal surface 146 without contacting the plate 120 because the shape characteristics and angle of the plate 120 at the top guide surfaces 154 is spaced away from the front surface of the rear rails 106 at an equal or greater distance as compared to the spacing of the protrusions 132 from the front surface of the rear rails 106. In other words, the top guide surface 154 may be angled relative to a longitudinal axis 160 of the front rail 110 at an angle X′ (shown in FIG. 13) that is greater than or equal to the angle X between the rear and front assemblies 102, 104. The protrusions 132 therefore cannot bind or press against the plates 120 or front rails 110 as they descend from the raised position of FIG. 13.

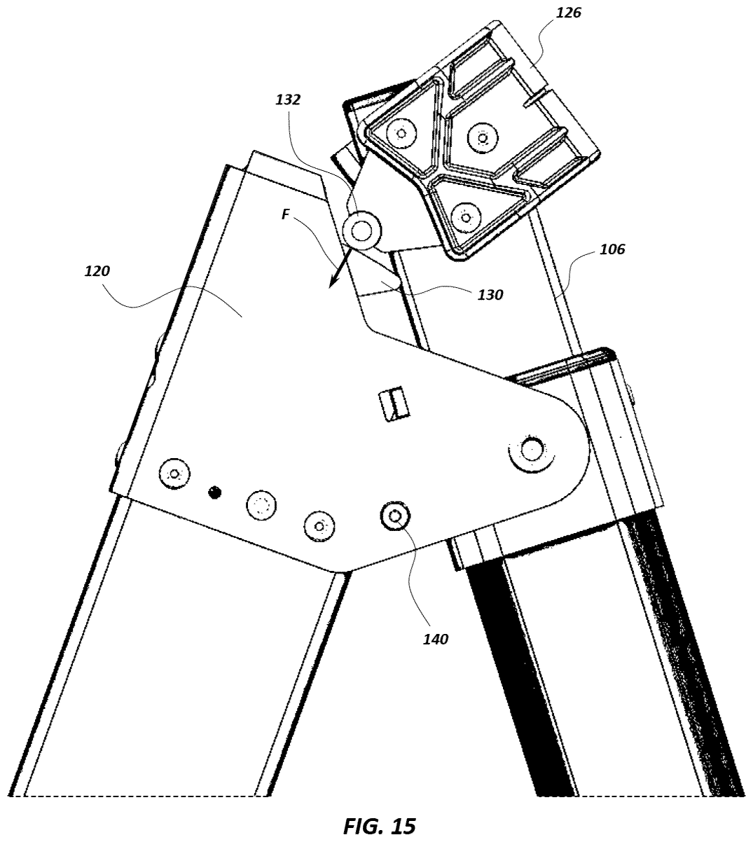

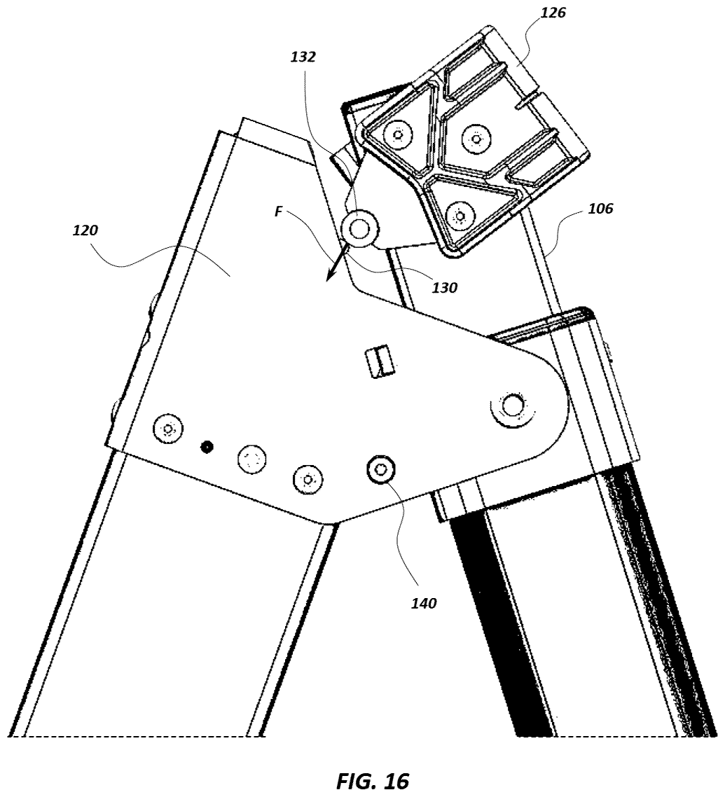

Once the protrusions 132 come into contact with the distal surfaces 146 of the retainers 130, continued downward movement of the rear rails 106 may cause the protrusions 132 to may apply a force F against the distal surfaces 146, as indicated in FIG. 14. When sufficient force F is applied by the protrusions 132, the protrusions 132 may apply a moment or torque to the retainers 130 that overcomes the biasing forces applied by the biasing members 144, thereby causing the retainers 130 to rotate in a forward direction about the pivoting connections 140, as shown in progression from the position of FIG. 15, with the protrusion 132 partially rotated behind the hinge plate 120, to the position of FIG. 16, with the protrusion 132 even further rotated, to the position of FIG. 17, with the protrusion 132 fully retracted behind the plate 120. Thus, the rotation of the retainers 130 can be referred to as a retraction or withdrawal of the retainers 130 away from the protrusions 132 and/or into a space between the front rails 110 and the hinge plates 120. The surface curvature of the distal surfaces 146 may be shaped such that the force F is applied by the protrusions 132 at substantially a single angle (relative to the vertical direction) as the retainers 130 move from their extended positions (FIG. 14) to their substantially fully retracted positions (FIG. 16). This can facilitate smooth operation of the locking mechanism and retainers 130 and slowly ramps up the force required to displace the retainers 130 (since the moment arm to the pivoting connections 140 gradually decreases) in order to avoid unintentional unlocking of the retainers 130.

Once the protrusion 132 has passed the tip of the retainer 130 (i.e., the tip portion of the retainer where the distal surface 146 curves to the proximal surface 136), as shown in FIG. 17, the force F applied by the protrusion 132 may no longer be applied to the retainer 130. Thus, in response to the protrusion 132 reaching the position of FIG. 17 past the tip, the biasing member 144 may, by virtue of its biasing force, rotate the retainer 130 about the pivoting connection 140 back to the position shown in FIG. 6. In this manner, the protrusion 132 returns to its locked position by moving the retainer 130 out of its way as it longitudinally descends, even if the rear rails 106 are in an angled orientation (e.g., at angle X) as they descend. A set of stop surfaces (e.g., on bent-in tabs 162 of the hinge plates 120) can limit the amount of rearward movement of the retainers 130 as they move into the position of FIG. 6 and thereby re-form the slots 134. See FIGS. 5-6.

The biased return of the retainers 130 can cause the retainers 130 to snap or click back into their locked positions (e.g., when moving from the position of FIG. 17 to the position of FIG. 6). This snap or click can provide audible and haptic/vibration feedback to the user to help the user recognize that the ladder 100 is now properly locked in its step ladder configuration and that the protrusions 132 will not slide upward any further if he or she begins to place a load on the ladder (e.g., the user steps on the rungs). Additionally, the retainers 130 can be visible to the user when looking at the top of the ladder 100 from its lateral sides, so the user can easily visually inspect the relative positions of the retainers 130 and protrusions 132 and thereby recognize whether the ladder 100 is locked in the step ladder configuration by observing that the retainers 130 are above the protrusions 132 (i.e., that the protrusions 132 are engaging the proximal surfaces 136).

In some examples, the rear assembly 102 can be locked relative to the front assembly 104 in the step ladder position of FIG. 6 by following a reverse course of action relative to the numbering of FIGS. 6-11. For example, the rear assembly 102 can be moved from the position of FIG. 11 to the position of FIG. 10, then to the position of FIG. 9, then to the position of FIG. 8, and then to the position of FIGS. 6-7. Thus, the ladder 100 does not have to begin in an open, A-frame, or step ladder configuration for the protrusions 132 to eventually reach a locked configuration. If the user so chooses, the protrusions 132 can be rotated into their locked positions in the slots 134 without contacting the distal surface 146 and without substantial (or in some cases, any) movement of the retainers 130.

Referring now to FIGS. 1-6, 19, and 20, the rear rails 106 may complete their sliding movements within the sliding support brackets 121. The sliding support brackets 121 can be referred to as hinge assemblies, bracket assemblies, shields, rail guides, or portions of the hinge assemblies. The upper brackets 128 and lower brackets 124 may each comprise a rigid, durable, and tough material such as steel, aluminum, or magnesium. The rigid and tough materials used in the upper and lower brackets 128, 124 can facilitate durable attachment of the lower brackets 124 to (or integration with) the spreader assemblies 118 and can facilitate durable attachment of the upper brackets 128 to the hinge plates 120.

The shrouds 122 of the sliding support brackets 121 may comprise a durable and tough material such as, for example, a metal, plastic, or composite material (e.g., aluminum, polyvinylchloride (PVC), or fiberglass). The shrouds 122 can beneficially be formed with fiberglass, plastics, or other lightweight composites to reduce the overall weight of the ladder 100 or to provide an electrically insulating/non-conductive material for a user's hands to grasp on the ladder 100. The shrouds 122 may connect the lower brackets 124 to the upper brackets 128 in a manner keeping the brackets 124, 128 aligned along the longitudinal axis of the rear rails 106. This can help prevent binding or twisting of the rails 106 as they slide through the sliding support brackets 121. The shrouds 122 can also beneficially have smooth outer surfaces that can act as side handles for a user climbing the rear assembly 102. In other words, the user may initially grasp the rear rails 106 when stepping onto the ladder 100 and, after reaching a certain point in his or her ascent, their hands can transition to grasping the shrouds 122. The outer shapes of the shrouds 122 may be similar in profile shape (e.g., substantially rounded rectangles), like the rear rails 106, so that the user's hand easily and comfortably transitions from grasping the rails 106 to grasping the shrouds 122 as he or she climbs.

The upper and lower brackets 128, 124 and shrouds 122 may all have C-shaped cross-sectional profiles that permit the sliding of the rear rungs 108 between the open portions 164 of the C-shapes. See, e.g., FIGS. 5 and 18. Thus, the rear rungs 108 may not come into contact with the sliding support brackets 121 and can slide through the open portions 164 as needed while the rear assembly 102 is extended or retracted. The lower brackets 124 may come into contact with the feet 116 to prevent the rear assembly 102 from sliding to a position completely removed from the sliding support brackets 121 as the rear assembly 102 moves upward. The upper brackets 128 may come into contact with the v-bar 126 (or protrusions 132) to prevent the rear assembly 102 from being completely removed while sliding through the sliding support brackets 121 downward, as shown in FIGS. 9-11.

FIG. 18 shows the spreader assemblies 118 in a deployed and locked configuration. Each of the spreader assemblies 118 may include a first spreader member 170 (e.g., a rear spreader member) directly pivotally coupled with a rear bracket 172 (or a rear bracket portion of the lower bracket 124) that is coupled with the rear rails 106 (or with the lower bracket 124). Each of the spreader assemblies 118 may also include a second spreader member 174 (e.g., a front spreader member) directly pivotally coupled with a front bracket 176 that is coupled with a front rail 110 or a front rung 112. The first spreader member 170 and the second spreader member 174 may be rotatably coupled with each other between the front rail 110 and the rear rail 106. A spreader coupling bracket 178 can be directly coupled to the spreader members 170, 174 as a connection point that also limits downward rotation of the inner ends of the spreader members 170, 174, when in the deployed/step ladder configuration, to the substantially horizontal positions shown in the right side central cross-section of FIG. 19.

The spreader assemblies 118 can have the first and second spreader members 170, 174 both positioned on respective lateral inner sides of the rear and front rails 106, 110, as shown in FIG. 18. The rear brackets 172 and front brackets 176 can also be positioned on laterally inward sides of the rear and front rails 106, 110. In some embodiments, the brackets 172, 176 can be pivotally connected to the spreader members 170, 174 via vertical side plate portions 173 that are positioned laterally internal to the ends of the spreader members 170, 174. Horizontal cross-sectional profiles of the brackets 172, 176 can each define L-shapes, with the spreader members 170, 174 being directly coupled to the side plate portions 173 of the L-shapes. The brackets 172, 176 can also include respective stop portions 180, 182 as other segments of the L-shapes and positioned further rearward (in the case of portion 180) or forward (in the case of portion 182) relative to their directly coupled spreader 170, 174. See FIGS. 18-19. The stop portions 180, 182 can block rotation of the spreaders 170, 174 when the ladder 100 is collapsed, as explained in further detail below.

When the spreader assemblies 118 are folded into a collapsed configuration, as shown in at least FIGS. 3 and 20, the spreader members 170, 174 can pivot at the brackets 172, 176 and at the coupling bracket 178. In a final position, the spreader assemblies 118 can be entirely positioned between a front plane 110-F defined by the front faces of the front rails 110 and a rear plane 106-R defined by the rear faces of the rear rails 106. In some embodiments, the spreader assemblies can be entirely positioned between a front plane 102-F defined by the front-most surfaces of the front assembly 104 and a rear plane 104-R defined by the rear-most surfaces of the rear assembly 102 while the ladder 100 is in the fully collapsed condition.

Furthermore, the stop portions 180, 182 of the spreader assemblies 118 may mechanically interfere with, and thereby prevent, any rotation of the spreader members 170, 174 in a forward or rearward direction beyond the front and rear planes defined above. In this manner, the spreader assemblies may be prevented from rotating beyond a volumetric envelope collectively defined by the first assembly 102 and the second assembly 104 (e.g., between planes 110-F/106-R or 102-F/104-R) while the ladder 100 is in the collapsed condition. Additionally, in some embodiments, the rear stop portion 180 can prevent rotation of the first spreader member 170 into a volumetric envelope defined between front and rear surfaces of the shrouds 122 or rear rails 106. These stop portions and range-limiting features for the spreader assemblies 118 can help minimize and avoid damage to the spreader assemblies 118 and can ensure a minimized profile of the ladder 100 for storage, shipping, and transportation.

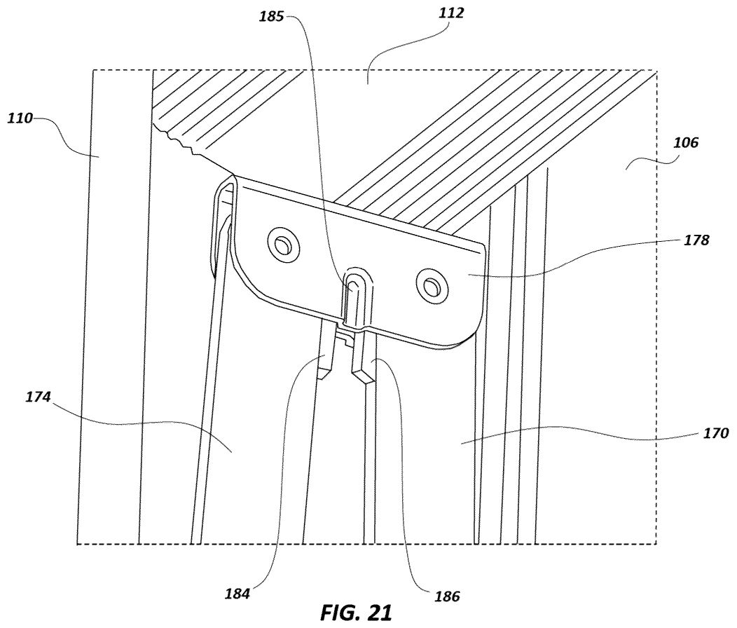

FIG. 21 shows an isometric detail view of an alternative example of the lateral inner side of a front rail 110 with the first and second spreader members 170, 174 in a collapsed position. In this example, the spreader members 170, 174 each include a thickened portion 184, 186 configured to fit within the spreader coupling bracket 178 when in the collapsed configuration. The thickened portions 184, 186 can also be referred to as protrusions or increased breadth sections of the spreader members 170, 174. The thickened portions 184, 186 can be configured to engage an inner surface of a recess 185 within the spreader coupling bracket 178. In this manner, the spreader members 170, 174 can be substantially prevented from rotating relative to the spreader coupling bracket 178 while in the collapsed condition because the thickened portions 184, 186 mechanically interfere with and engage inner stop surfaces of the spreader coupling bracket 178 to the front and rear of the recess 185. Thus, the thickened portions 184, 186 can be implemented in some examples of the ladder 100 to prevent the spreader assemblies 118 from moving outside the volumetric envelope of the front and rear planes of the ladder 100, as described in detail above.

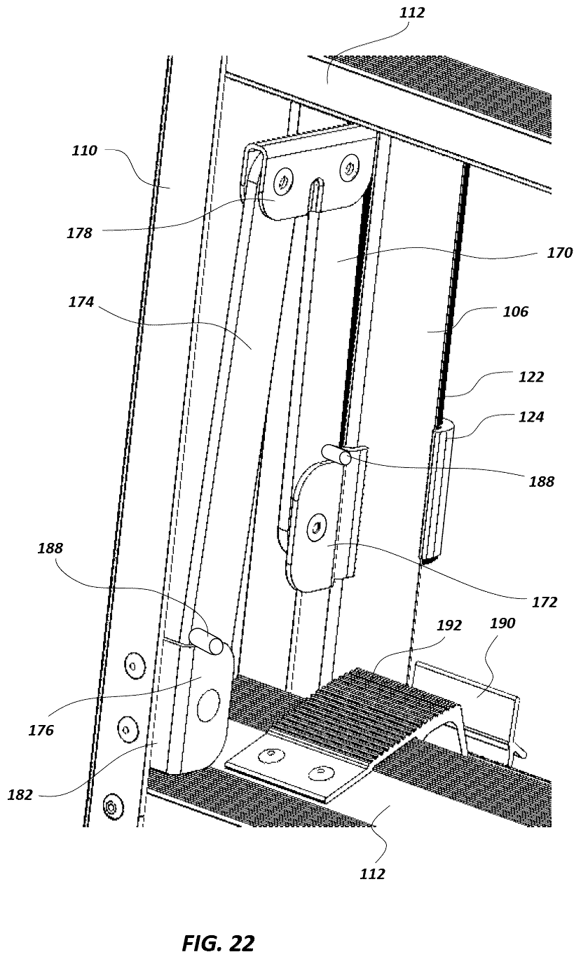

FIG. 22 illustrates an isometric detail view of another alternative example of the lateral inner side of the front rail 110 with the first and second spreader members 170, 174 in a collapsed position. In this example, the spreader members 170, 174 each include a protrusion 188 configured to mechanically interfere with a bracket 124, 172, 176, shroud 122, or rail 106, 110 when the spreader assemblies 118 are in the collapsed configuration. In various examples, the protrusions 188 can extend laterally inward, outward, or in both lateral directions from the spreader members 170, 174 to engage different nearby parts and features of the ladder 100. The protrusions 188 can comprise abutment members, pegs, fasteners (e.g., rivets), flanges, tabs, bumps, similar features, and combinations thereof. In some cases, a protrusion 188 can engage a top surface of the rear bracket 172 or the front bracket 176 in a manner that prevents rotation of the respective connected spreader member 170, 174 past a predetermined angle. The maximum displacement of the spreader members 170, 174 while collapsed can be defined by where the protrusions 188 engage the brackets 172, 176 while or after the ladder 100 is closed. In some examples, the protrusions 188 can have their angular displacements limited in a manner that keeps the spreader assemblies 118 from moving outside the volumetric envelope of the front and rear planes of the ladder 100, as described in detail above.

Referring now to FIGS. 3, 4, 20, and 23, the rear assembly 102 of the ladder 100 can be maintained in the collapsed position relative to the front assembly 104 due to placement of a rear rung 108 within a set of rung retainers 190 extending from the front assembly 104. See also FIGS. 18, 19, and 22. The rung retainers 190 can alternatively be referred to as rung hooks, rung support members, straight ladder retainers, or rear assembly retention hooks. The rung retainers 190 can be affixed to a front rung 112 and/or front rails 110 of the front assembly 104. In some examples, the rung retainers 190 can include top step surfaces 192 (see FIG. 22) configured with ribbing or a rough texture to provide traction and grip for a user standing on the rung 112 that has the rung retainers 190 attached to it. With a rear rung 108 positioned in the rear recesses of the rung retainers 190, the rear assembly 102 can be prevented from rotating about the pivotal connections 129 beyond the width of the top recesses of the rung retainers 190, if at all.

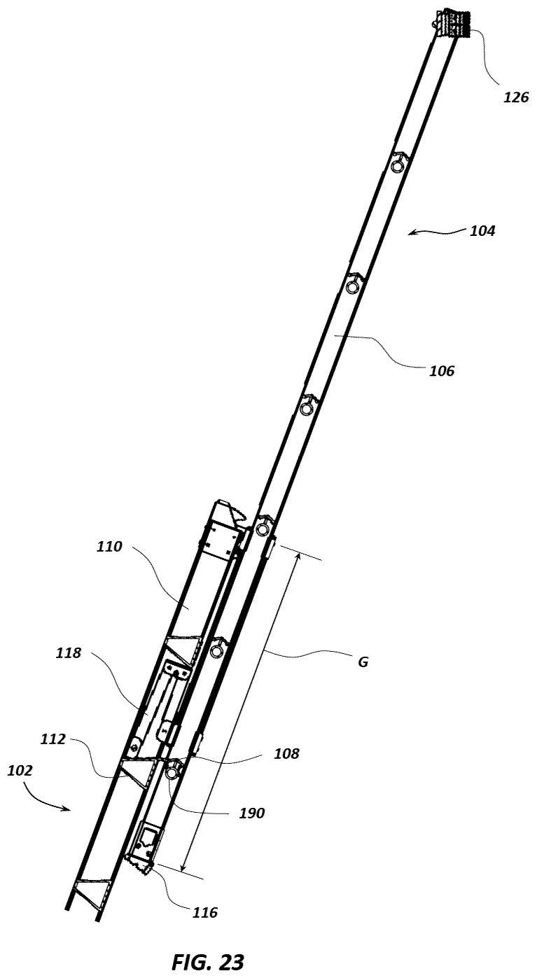

The rear assembly 102 can longitudinally slide between different positions, wherein different rear rungs 108 at different longitudinal positions on the rear rails 106 can be selectively positioned within the rung retainers 190. For different rungs 108, the overall adjusted length of the ladder 100, from the front feet 114 to the v-bar 126, can change. Thus, the rung retainers 190 can hold the ladder 100 in a collapsed configuration or in a straight ladder configuration dependent on which rear rung 108 is being retained in place by the rung retainers 190. In the example shown in FIG. 20, the second-from-top rung 108 is retained, and the ladder 100 is in a collapsed configuration with the rear assembly 102 retracted. In the example shown in FIG. 23, the bottom rung 108 is retained by the rung retainers 190, and the ladder is in the extended, straight ladder configuration with the rear assembly 102 extended.

The rung retainers 190 can include J- or U-shaped side profiles, as shown in FIGS. 18-20 and 23, that can support the bottom surfaces of the rear rungs 108. In some examples, the rear rungs 108 can include rounded bottom surfaces, and the rung retainers 190 can have flared top recesses (i.e., with broader top ends of the recesses as compared to the widths below the top ends) to help facilitate funneling and guiding the rungs 108 into the rung retainers 190. Additionally, rounded bottom surfaces of the rear rungs 108 can improve ergonomic comfort of a user grasping and lifting the rear assembly 102 by placing a hand under a rung 108.

The rung retainers 190 may be implemented in a set of two individual rung retainer hooks spaced apart from each other at opposite ends of the rung 112 of the front assembly 104, as shown in at least FIG. 18. The spacing between the separate rung retainers 190 can enable a user's hand to move between the rung hooks while gripping a rear rung 108 and sliding the rear assembly 102 longitudinally upward or downward. Thus, the user's hand and fingers can pass between the rung retainers 190 while moving the rear assembly 102 in a manner that avoids pinching or other compression of the hand between the rung retainers 190 and the rung 108, as could be the case if the rung retainers 190 included one hook extending across substantially the full lateral length of the front rung 112.

In various examples, the rung retainers 190 can be located extending from a second-from-top rung 112 of the front assembly 104. This positioning can ensure that when the ladder 100 is in the straight ladder configuration, there is a minimum overlap length G between the front and rear rails, as shown in FIG. 23. Length G is defined from the bottom ends of the rear rails 106 to the top ends of the front rails 110 while the rear rails 106 are in their most extended position having a rung 108 retained by a rung retainer 190.

The rear assembly 102 cannot be mounted to the rung retainers 190 with an overlap length less than minimum overlap length G because the bottom-most rung 108 of the rear assembly 102 is mounted to the rung retainers 190, and no lower portions of the rear assembly 102 can be mounted to the rung retainers 190. The overlap length G can therefore be configured with a minimum value at least partially based on the distance between the pivotal connections 129 and the rung retainers 190, i.e., the two areas of contact between the front assembly 104 and the rear assembly 102, the additional rail overlap distance (if any) extending downward on the rear rails 106 from the bottom-most rung 108 to the feet 116, and the additional rail overlap distance (if any) extending upward from the pivotal connections 129 to the tops of the upper brackets 128. The minimum value of the overlap length G can be selected to ensure stability and limited bending of the ladder 100 while in the most extended straight ladder position possible, i.e., FIG. 23. In some examples, the minimum overlap length G may be designed to meet safety or construction standards based on characteristics of the ladder 100 such as its maximum possible length (from feet 114 to v-bar 126 in straight ladder configuration), the materials used in the ladder 100, the width of the rungs 108/112 or feet 114, similar characteristics, or combinations thereof.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A ladder, comprising:
a first assembly including a first pair of spaced apart rails and a first set of rungs coupled to and extending between the first pair of spaced apart rails;
a second assembly including a second pair of spaced apart rails and a second set of rungs coupled to and extending between the second pair of spaced apart rails;
a pair of brackets coupled with the second assembly and slidably receiving the first pair of spaced apart rails;
a pair of protrusions extending from the first pair of spaced apart rails; and
a pair of retainers movably coupled with the second pair of spaced apart rails and at least partially defining a pair of slots;
wherein the first pair of spaced apart rails is movable relative to the pair of brackets between a first configuration and a second configuration;
wherein, when in the first configuration, the first pair of spaced apart rails and the second pair of spaced apart rails are positioned at a nonzero angle relative to each other, and the pair of protrusions is positioned external to the pair of slots;
wherein, when in the second configuration, the first pair of spaced apart rails and the second pair of spaced apart rails are positioned at the nonzero angle relative to each other, and the pair of protrusions is positioned within the pair of slots; and
wherein, sliding movement of the first pair of spaced apart rails relative to the pair of brackets is configured to move the pair of retainers relative to the second pair of spaced apart rails.

2. The ladder of claim 1, wherein the pair of brackets is pivotable relative to the second assembly.

3. The ladder of claim 1, wherein the pair of protrusions extends laterally from the first pair of spaced apart rails.

4. The ladder of claim 1, wherein the pair of retainers are rotatably coupled with the second pair of spaced apart rails.

5. The ladder of claim 1, further comprising a pair of biasing mechanisms biasing movement of the pair of retainers relative to the second pair of spaced apart rails.

6. The ladder of claim 5, wherein the pair of retainers move against a pair of biasing forces applied by the pair of biasing mechanisms in response to a force applied by the pair of protrusions against the pair of retainers as the first pair of spaced apart rails moves relative to the pair of brackets from the first configuration to the second configuration.

7. The ladder of claim 1, wherein at least one retainer of the pair of retainers includes a hooked surface defining a slot of the pair of slots.

8. The ladder of claim 1, further comprising a shroud configured to cover a distal surface of at least one retainer of the pair of retainers.

9. The ladder of claim 1, wherein the first pair of spaced apart rails is movable from the first configuration to the second configuration while constantly maintaining the nonzero angle relative to the second pair of spaced apart rails.

10. A ladder, comprising:
a first assembly including:
a first pair of spaced apart rails,
a first set of rungs extending between and coupled to the first pair of spaced apart rails, and
at least one pin member laterally extending from the first pair of spaced apart rails;
a second assembly including:
a second pair of spaced apart rails,
a second set of rungs extending between and coupled to the second pair of spaced apart rails, and
at least one retainer member coupled with at least one rail of the second pair of spaced apart rails, the at least one retainer member being movable between an unlocked position relative to the at least one rail and a locked position relative to the at least one rail; and
a hinge assembly rotatably coupling the first assembly with the second assembly;
wherein the first pair of spaced apart rails and the second pair of spaced apart rails are movable via the hinge assembly to a spread apart configuration with an acute angle between the first pair of spaced apart rails and the second pair of spaced apart rails;
wherein, when in the spread apart configuration and with the at least one retainer member in the locked position, the first assembly is prevented from longitudinal movement relative to the hinge assembly due to contact between the at least one pin member and the at least one retainer member; and
wherein, when in the spread apart configuration and with the at least one retainer member in the unlocked position, the first assembly is longitudinally movable relative to the hinge assembly.

11. The ladder of claim 10, wherein the at least one retainer member at least partially defines a slot when in the locked position.

12. The ladder of claim 10, wherein the at least one pin member comprises a bar extending between top ends of the first pair of spaced apart rails.

13. The ladder of claim 10, wherein the second assembly further comprises at least one biasing member configured to apply a force to the at least one retainer member, the force biasing the at least one retainer member toward the locked position.

14. The ladder of claim 10, wherein the at least one retainer member is movable from the locked position to the unlocked position in response to a force applied by the at least one pin member against a distal surface of the at least one retainer member.

15. The ladder of claim 14, wherein the at least one retainer member is movable from the locked position to the unlocked position by the force applied by the at least one pin member against the distal surface of the at least one retainer member when the first pair of spaced apart rails and the second pair of spaced apart rails are at the acute angle.

16. The ladder of claim 10, wherein the first assembly comprises a cover member configured to limit user access to a distal surface of the at least one retainer member when the at least one pin member is contacting a proximal surface of the at least one retainer member.

17. A ladder, comprising:
a first assembly including:
a first pair of spaced apart rails;
a first set of rungs extending between and coupled to the first pair of spaced apart rails; and
a second assembly including:
a second pair of spaced apart rails;
a second set of rungs extending between and coupled to the second pair of spaced apart rails; and
at least one spreader assembly including:
a first spreader member rotatably coupled with a first rail of the first pair of spaced apart rails; and
a second spreader member rotatably coupled with a second rail of the second pair of spaced apart rails, the second spreader member being rotatably coupled with the first spreader member between the first rail and the second rail;
wherein the at least one spreader assembly is movable between an extended configuration and a collapsed configuration;
wherein, when in the extended configuration, the at least one spreader assembly holds apart the first rail and the second rail; and
wherein, when in the collapsed configuration, a portion of the at least one spreader assembly prevents rotation of the first spreader member or the second spreader member beyond a volumetric envelope collectively defined by the first assembly and the second assembly.

18. The ladder of claim 17, wherein the portion of the at least one spreader assembly comprises a bracket limiting a range of rotation of the first spreader member beyond the volumetric envelope.

19. The ladder of claim 17, wherein the portion of the at least one spreader assembly comprises an abutment member extending laterally from the first spreader member between an outermost surface of the first rail and an outermost surface of the second rail, the abutment member being configured to engage at least one of the first rail and the second rail in response to rotation of the first spreader member relative to the first rail.

20. The ladder of claim 17, wherein the portion of the at least one spreader assembly includes a stop surface on the first spreader member, the stop surface being configured to engage the second spreader member when in the collapsed configuration.
